(19) United States
(12) Patent Application Publication
(10) Pub. No.: US 2018/0059501 A1
(43) Pub. Date: Mar. 1, 2018

(54) PARTICLES HAVING VARYING REFRACTIVE INDEX

(71) Applicant: 3M INNOVATIVE PROPERTIES COMPANY, St. Paul, MN (US)

(72) Inventors: Andrew J. Ouderkirk, St. Paul, MN (US); Audrey A. Sherman, Woodbury, MN (US); Michael D. Crandall, Sparks, NV (US); Brett J. Sitter, Cottage Grove, MN (US); Zhipeng Song, Chadds Ford, PA (US); Jenna M. Lundquist, Apple Valley, MN (US); Belma Erdogan-Haug, Woodbury, MN (US); Albert I. Everaerts, Tucson, AZ (US); Robert L. Brott, Woodbury, MN (US)

(21) Appl. No.: 15/556,031

(22) PCT Filed: Apr. 12, 2016
(86) PCT No.: PCT/US2016/027033

§ 371 Date: Sep. 6, 2017

Related U.S. Application Data
(60) Provisional application No. 62/148,850, filed on Apr. 17, 2015.

(51) Int. Cl. G02F 1/19; C08F 212/08; C08F 257/02; C08F 285/00

(52) U.S. Cl. CPC G02F 1/19; C08F 285/00; C08F 257/02; C08F 212/08

(57) ABSTRACT

Particles having a first region and a second region surrounding the first region where the second region includes a copolymer extending across a thickness of the second region are described. The volume of the second region is at least 75 percent of the volume of the particle. The particles have a composition and a refractive index that each vary across the thickness of the second region.

### BACKGROUND

Particles may be incorporated into a medium to affect the optical or physical properties of the medium.

U.S. Pat. No. 8,865,797 (Matyjaszewski et al.) describe a core-shell composite particle for incorporation into a composite where the composite has improved transparency. The core-shell composite particle includes a core material having a first refractive index and a shell material having a second refractive index where the core-shell particle has an effective refractive index determined by the first refractive index and the second refractive index. The effective refractive index is substantially equal to the refractive index of the envisioned embedding medium.

U.S. Pat. No. 8,133,938 (Munro et al.) describes a radiation diffraction material comprising an ordered periodic array of particles held in a polymeric matrix. The particles each have a core surrounded by a shell.

“Onion-like” multilayered poly(methyl methacrylate (PMMA)/polystyrene (PS) composite particles can be prepared by the solvent-absorbing/releasing method as described in Okubo et al., Colloid Polym. Sci. 279, 513-518 (2001).

Particles having a polystyrene core and four alternating layers of polystyrene and poly(trifluoroethyl methacrylate) can be made using a five-stage polymerization series as described in Gourevich et al., Macromolecules 39, 1449-1454 (2006).

### SUMMARY

In some aspects of the present description, a particle having a first region and a second region surrounding the first region is provided. A volume of the second region is at least 75 percent of a volume of the particle and the second region includes a copolymer extending across a thickness of the second region. The particle has a composition and a refractive index that each vary across the thickness of the second region.

In some aspects of the present description, a method of making a particle is provided. The method includes providing a seed; providing monomers; reacting the monomers adjacent a surface of the seed; and growing the particle until the particle has an outer diameter at least twice a diameter of the seed by reacting the monomers adjacent a surface of the growing particle. The monomers are continuously provided to the growing particle and a composition of the monomers provided to the growing particle is changed with time.

In some aspects of the present description, an article having one or more ordered layers of particles is provided. At least some of the particles have a refractive index that varies over at least 50 percent of a diameter of the particle. When a collimated beam of light passes through the article, a light output distribution comprises a central lobe region, a ring region, and a low intensity region separating the central lobe region and the ring region.

### BRIEF DESCRIPTION OF THE DRAWINGS

FIG. 1 is a schematic cross-sectional view of a particle;

FIGS. 2-4 are a graphs of refractive index as a function of radial coordinate;

FIGS. 5-6 are schematic cross-sectional views of a particles;

FIG. 7 is a graph of refractive index as a function of radial coordinate;

FIG. 8 is a cross-sectional view of a layer including a plurality of particles;

FIG. 9 is a plot of a light output distribution as a function of scattering angle;

FIG. 10 is a cross-sectional view of a multilayer film having a layer including a plurality of particles;

FIG. 11 is a schematic cross-sectional view of a film or layer disposed on a display;

FIG. 12 is a cross-sectional view of ordered layers of particles;

FIG. 13 is a schematic illustration of a reactor for making particles; and

FIGS. 14-16 are plots of light output distributions as functions of scattering angle.

### DETAILED DESCRIPTION

In the following description, reference is made to the accompanying drawings that forms a part hereof and in which are shown by way of illustration. The drawings are not necessarily to scale. It is to be understood that other embodiments are contemplated and may be made without departing from the scope or spirit of the present disclosure. The following detailed description, therefore, is not to be taken in a limiting sense.

It is sometimes desired to include particles in an adhesive or other polymeric material in order to alter the optical properties of the adhesive or other material. The particles may be chosen to have a suitable refractive index to achieve the desired optical properties. Particles having a thin shell around a core are sometimes used where the shell and the core have differing refractive indices. However, according to the present description it has been found that particles having a refractive index that varies through a substantial portion (e.g., at least ½ of the diameter, or at least 75 percent of the volume) of the particle can give desired optical properties that are not obtained with conventional core-shell particles.

Particles having multiple polymeric layers where the layers are not covalently bonded to each other have been described previously. However, since there are no covalent bonds attaching the separate layers together, the particles are not robust and so their applicability to coatings, for example, is limited. For example, since the layers are attached through interfacial adhesion only, the particle may be prone to damage during normal processing of coatings. This is particularly problematic when a large refractive index difference is desired between the layers since it may be desired to use a fluoropolymer for the low index layer and a fluoropolymer layer would typically have poor interfacial adhesion to an adjacent layer.

Furthermore, particles having layers bonded only through interfacial adhesion may be prone to damage arising from swelling when dispersed in a solution since the different layers may have different swelling characteristics. According the present description, it has been found that particles having copolymers extending through a substantial portion (e.g., at least ½) of the diameter of the particle can be formed. The particles may have alternating layers that are covalently bonded together through the copolymers which extend from layer to layer. It has also been found that particles having a continuously varying composition and a continuously varying refractive index through at least a substantial portion (e.g., at least 75 percent of the volume) of the particle can be formed. Such particles have desirable optical properties and are more robust than conventional layered particles.

The particles may be incorporated into a film or an ordered layer or layers of particles may be provided. The film or ordered layer(s) may provide a controlled scattering of light transmitted through the film or ordered layer(s). As described further elsewhere herein, the controlled scattering may provide a light output distribution having a central lobe region, a ring region and a low intensity region separating the central lobe and ring regions. Such light output distributions may be useful in providing an anti-sparkle effect, for example.

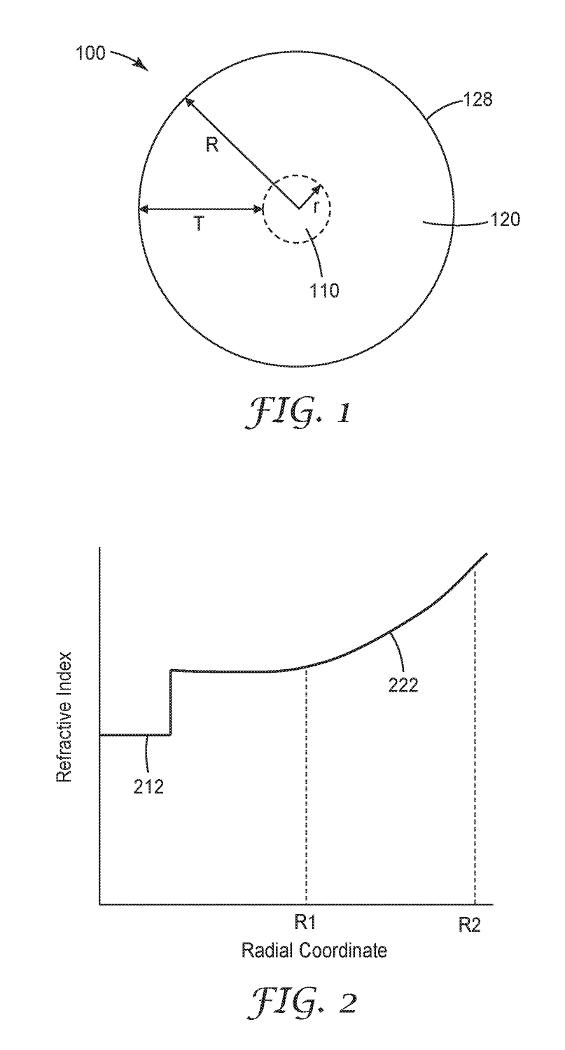

FIG. 1 is a schematic cross-sectional view of particle 100 including first region 110 and second region 120 surrounding and enclosing first region 110. The particle 100 has an outer surface 128 and an outer radius of R, which is also the outer radius of the second region 120. First region 110 has an outer radius of r. Particle 100 can be grown from a seed by polymerizing monomers adjacent a surface of the seed and then growing the particle by continuously reacting monomer at or near a surface of the growing particle. This may be done in a reactor having a plurality of seeds dispersed in solution. The seed particle may correspond to the first region 110 and the portion of the particle formed by reacting monomers may correspond to the second region 120. In some embodiments, the monomers initially reacted adjacent the surface of the seed may have a composition that matches or substantially matches the composition at the surface of the seed so that there may be no physical interface between first region 110 and second region 120. In this case, the first region may refer to a region near a center of a particle having a substantially uniform composition and refractive index and second region 120 may refer to a region surrounding first region 110. In some embodiments, the monomers reacted adjacent the seed, may have a composition different from that of the seed, so that a physical interface separates first region 110 and second region 120.

The composition of the monomers may be varied continuously so that the particle has a continuously varying composition and a continuously varying refractive index across the thickness T of the second region. Alternatively, the composition of the monomers may be varied discontinuously to form layers as described further elsewhere herein. In embodiments where the monomer reacted adjacent the seed have the same composition as the seed, the particle 100 may have a composition and a refractive index that each vary continuously from a center of the particle 100 to an outer surface of the particle 100. By continuously supplying monomers to the growing particle, the resulting particle can include copolymers which extend across the thickness T of the second region 120, whether the composition is varied continuously or discontinuously.

Suitable monomers include styrene, (meth)acrylates, vinyl compounds, alkenes, fluorinated compounds, monomers with high refractive index as exemplified in U.S. Pat. No. 8,378,046 (Determan et. al.), and any ethylenically unsaturated monomeric compound suitable for polymerization.

The monomers may react through chain growth polymerization and initiators and/or catalysts may be provided to the reactor containing the growing particles. Polymerization initiators useful in preparing the particles are initiators that, on exposure to heat, generate free-radicals, which initiate (co)polymerization of the monomer mixture. Water-soluble and/or oil-soluble free radical polymerization initiators can be used. In some embodiments, it may be desired to use water-soluble initiators. Suitable water-soluble initiators include but are not limited to those selected from the group consisting of potassium persulfate, ammonium persulfate, sodium persulfate, and mixtures thereof, oxidation-reduction initiators such as the reaction product of the above-mentioned persulfates and reducing agents such as those selected from the group metabisulfites, formaldehyde sulfoxylate, 4,4′-azobis(4-cyanopentanoic acid) and its soluble salts (e.g., sodium, potassium). Examples of useful oil-soluble initiators include but are not limited to those selected from the group consisting of diazo compounds such as Vazo™ 64 (2, 2′-azobis(isobutyronitrile), Vazo™ 52 (2, 2′-azobis(2, 4-dimethylpentanenitrile), both available from duPont, peroxides such as benzoyl peroxide and lauroyl peroxide, and mixtures thereof.

In some embodiments, a cross-linker may also be included. Polyethylenically unsaturated compounds, such as multifunctional acrylates are useful as crosslinking agent in bulk or emulsion polymerization processes. Examples of polyethylenically unsaturated compounds include, but are not limited to, polyacrylic-functional monomers such as ethylene glycol diacrylate, propylene glycol dimethacrylate, bisphenol-A di(meth)acrylate, trimethylolpropane triacrylate, 1,6-hexanedioldiacrylate, pentaerythritol di-, tri-, and tetraacrylate, and 1,12-dodecanedioldiacrylate; olefmic-acrylic-functional monomers such as allyl methacrylate, 2-allyloxycarbonylamidoethyl methacrylate, and 2-allylaminoethyl (meth)acrylate; allyl 2-acrylamido-2,2-dimethylacetate; divinylbenzene; vinyloxy group-substituted functional monomers such as 2-(ethenyloxy)ethyl (meth)acrylate, 3-(ethynyloxy)-1-propene, 4-(ethynyloxy)-1-butene, and 4-(ethenyloxy)butyl-2-acrylamido-2,2-dimethylacetate, and the like.

In some embodiments, the volume of the second region 120 is at least 60 percent, at least 75 percent, at least 85 percent, or at least 90 percent, or at least 95 percent, or at least 99 percent, or at least 99.9 percent of the volume of the particle 100. In some embodiments, the volume of the second region 120 is in a range of 75 percent or 85 percent to 99.999 percent or to 99.9999 percent of the volume of particle 100. In some embodiments, the outer radius, R, of the second region 120 is at least 1.5 times, 2 times, 5 times, 10 times, or 30 times the outer radius, r, of the first region 110. In some embodiments, the outer diameter, 2 times R, of the second region 120 is at least 1.5 times, 2 times, 5 times, 10 times, or 30 times the outer diameter, 2 times r, of the first region 110. The particle 100 may be substantially spherical, or it may have an ellipsoidal or other shape. The radius or diameter of the particle may refer to an equivalent radius or diameter of a sphere having the same volume as the particle. In some embodiments, the outer radius, R, of the second region 120 is in a range of 2 to 10000 times the outer radius, r, of the first region 110. In some embodiments, the first region 110 has a diameter (2 times r) in the range of about 1 nm to about 400 nm. In some embodiments, the particle 100 has an outer diameter (2 times R) in a range of about 100 nm to about 10 micrometers.

FIG. 2 is a schematic illustration of a refractive index of a particle as a function of radial coordinate (For example, in a spherical coordinate system (r, θ, φ), the radial coordinate is the r coordinate. For an ellipsoidal or otherwise non-spherical particle, the radial coordinate of a point may refer to the distance between the point and a center or centroid of the particle.). The refractive index 212 of the first region of the particle is substantially constant and the refractive index 222 of the second region of the particle is continuously varying across a thickness of the second region. In the illustrated embodiments, the refractive index is not continuous from the first region to the second region.

The refractive index may vary at a nonzero first rate at a first position and at a nonzero second rate different from the first rate at a second position different from the first position. For example, the first position may be position R1 and the second position may be position R2 which is further from the center of the particle than position R1. In some cases, the second position may be near the center of the particle or in a portion of the second region closest to the first region and the second position may be near an outer surface of the particle or in a portion of the second region closest to the outer surface of the particle. In some cases, the first and second positions are radially separated by at least 80 percent, or at least 85 percent, or at least 90 percent of the thickness of the second region. The rate of variation of the refractive index may be understood to be the magnitude of the derivative of the refractive index with respect to the radial coordinate. In some embodiments, such as the embodiment illustrated in FIG. 2, the refractive index varies more rapidly at the second position than at the first position.

In some embodiments, an absolute value of a derivative of the refractive index with respect to the radial coordinate monotonically increases with increasing radial coordinate across the thickness of the second region or monotonically increases with increasing radial coordinate across at least 80 percent, or at least 90 percent, or substantially all of the thickness of the second region. In some embodiments, the refractive index varies parabolically (either increasing or decreasing) over at least a portion of the second region and in some embodiments the refractive index varies parabolically (either increasing or decreasing) over all or substantially all of the second region. For embodiments in which the refractive index varies parabolically, the absolute value of a derivative of the refractive index with respect to the radial coordinate monotonically increases linearly with the radial coordinate. In other embodiments, the absolute value of the derivative of the refractive index with respect to the radial coordinate may increase more slowly or more rapidly than a linear increase, or may increase more slowly in some portions of the second region and more rapidly in other portions of the second region compared to a linear increase.

An alternate embodiment is shown in FIG. 3, which is a schematic illustration of a refractive index of a particle as a function of radial coordinate. The refractive index 322 in the second region is monotonically increasing while the refractive index 312 in the first region is substantially constant. In this case, the refractive index is a continuous function of the radial coordinate from a center of the particle to an outer surface of the particle. The composition of the particle may also be a continuous function of the radial coordinate from the center of the particle to an outer surface of the particle.

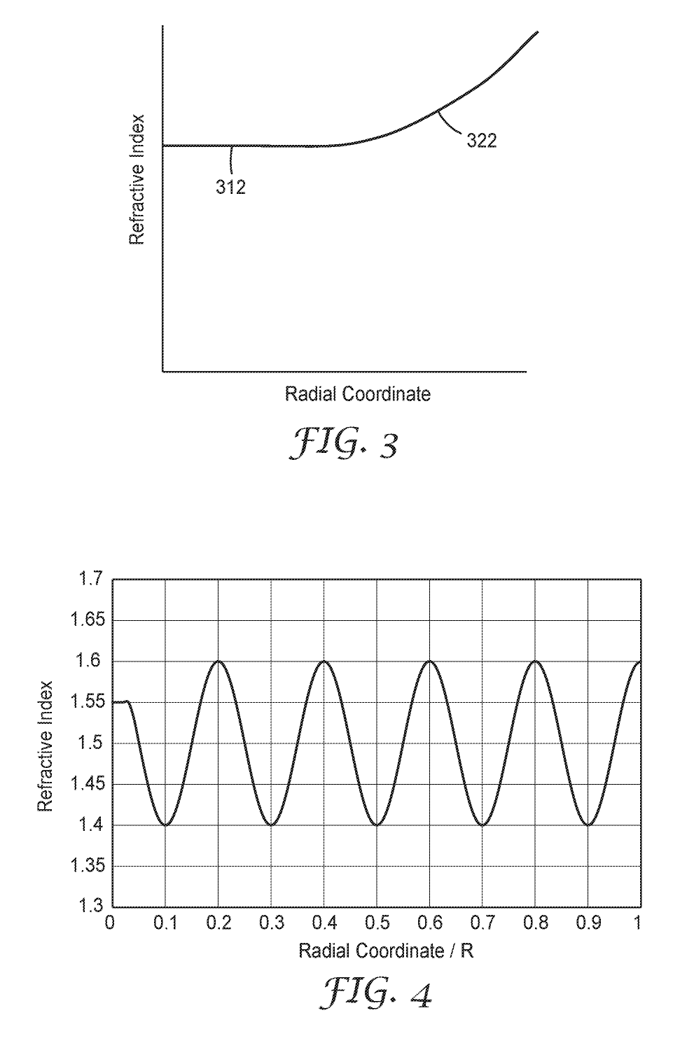

In the embodiments illustrated in FIGS. 2-3, the refractive index is monotonically increasing across the thickness of the second region. In other embodiments, the refractive index may monotonically decrease across the thickness of the second region. In still other embodiments, the refractive index may vary non-monotonically across the thickness of the second region. FIG. 4 is a schematic illustration of a refractive index of a particle as a function of radial coordinate. In this case, the refractive index varies non-monotonically across the thickness of the second region. More specifically, in this case, the refractive index has a substantially sinusoidal variation across the thickness of the second region.

In some embodiments, a difference between a maximum refractive index in the second region and a minimum refractive index in the second region is at least 0.05, or at least 0.1, or at least 0.15, and may be in a range of 0.05 to 0.3. In some embodiments, the refractive index has a substantially sinusoidal variation across the thickness of the second region with an amplitude of at least 0.05, or at least 0.1, or at least 0.15. In the embodiment illustrated in FIG. 4, the amplitude of the sinusoidal variation is about 0.2. Unless specified differently, refractive index or index of refraction refers to refractive index for light having a wavelength of 589 nm (sodium D line) at 25° C.

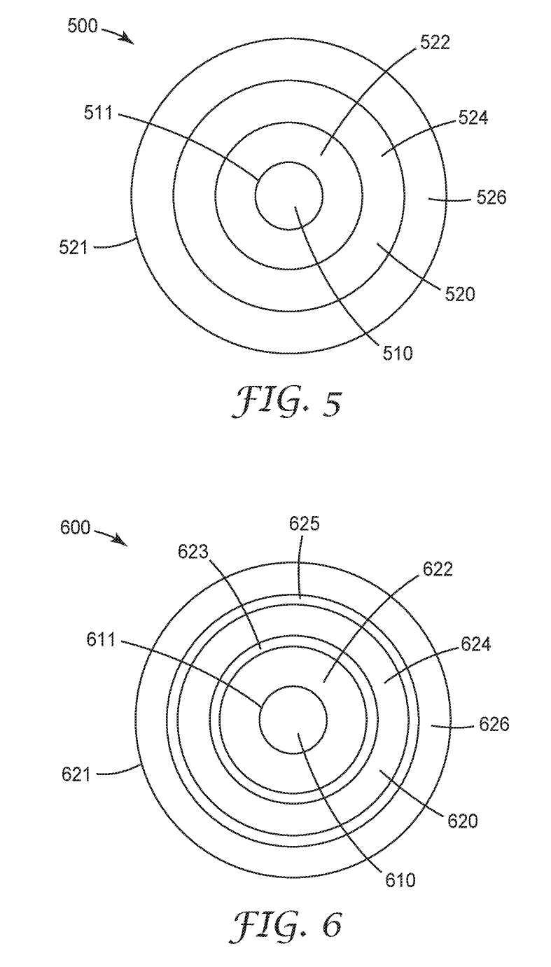

FIG. 5 is a cross-sectional view of particle 500 having first region 510 and second region 520 having a plurality of mutually concentric layers. First region 510 may correspond to a seed particle having an outer surface 511. Second region 520 has an outer surface 521 and mutually concentric first, second and third layers 522, 524, and 526. Particle 500 can be prepared by growing the particle from a seed where monomers are continuously supplied to the growing particle but a composition of the monomers are discontinuously varied resulting in the three distinct layers 522, 524, and 526. By continuously supplying monomers to the growing particle, the monomers of a first layer react with polymers formed in the adjacent layer to form a copolymer that extends from outer surface 511 of the seed to outer surface 521 of the particle. For example, first layer 522 may be grown by providing monomers of a first monomer type to the growing particle. The monomers react with a growing chain in the layer to grow the layer. The composition of the monomers may be abruptly changed and monomers of a second type may be provided. Since the monomers are continuously supplied, the monomers of the second type react with a growing chain started in first layer 522 to form second layer 524. The composition of the monomers may be abruptly changed again and monomers of a third type may be supplied to continue growing the polymer chains started in the first layer 522 and continued through the second layer 524 to form the third layer 526. The second type of monomers may be different from the first and the third type of monomers. The first and third type of monomers may be the same or may be different. The monomers used in each of the layers may be distinct, or different blends of the same group of monomers may be used in the different layers. Particles made in this way have covalent bonds between adjacent layers and are more robust than particles with adjacent layers bonded only through interfacial adhesion.

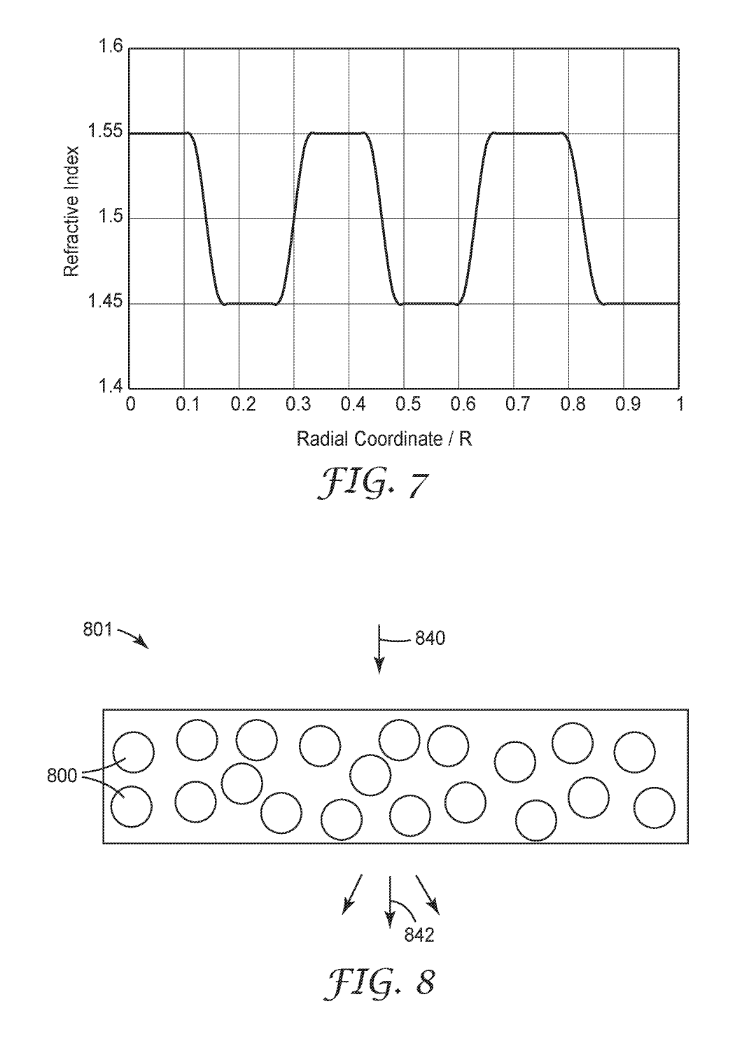

Particle 500 has a refractive index and composition that varies discontinuously across the second region 520. In some cases it may be desired to provide transition regions between the various layers where the refractive index varies continuously from that in one layer to that in an adjacent layer. This may soften the optical effects of a discontinuity in the refractive index while retaining desirable optical properties of the particle. This is illustrated in FIGS. 6 and 7.

FIG. 6 is a cross-sectional view of particle 600 having first region 610 and second region 620 comprising a plurality of mutually concentric layers. First region 610 may correspond to a seed particle having an outer surface 611. Second region 620 has an outer surface 621; and first, second and third layers 622, 624 and 626; and first and second transition regions 623 and 625. Particle 600 can be made as described for particle 500, except that instead of abruptly varying the composition of the monomers in transitioning from one layer to the next, the composition varies continuously to form the first and second transition regions 623 and 625. The composition and the refractive index may vary continuously across each transition region. By including the transition regions, the composition and refractive index may vary continuously from outer surface 611 of the seed to outer surface 621 of the particle 600. In some embodiments, an additional transition region is included between first region 610 and first layer 622 so that the composition and refractive index varies continuously from the center of the particle to the outer surface 621 of the particle.

Each transition region may have a thickness greater than 30 nm or greater than 50 nm. Each transition region may have a thickness less than one half or one third or one fifth of the minimum thickness of the layers adjacent the transition region. For example, first transition region 623 may have a thickness less than ½ or ⅓ or ⅕ of the thickness of the thinner of first layer 622 and second layer 624.

FIG. 7 shows the refractive index as a function of radial coordinate for a particle having an outer radius of R. The particle has a first region, which may correspond to a seed, having a refractive index of 1.55 and extending from the center of the particle to a radius of about 0.1 times R. The particle includes 5 layers with refractive indices alternating between 1.45 and 1.55. Transition regions are included between each layer and between the first region and the first layer. The refractive index, and the composition of the particle, varies continuously from the center of the particle to an outer surface of the particle. In alternate embodiments, the transition regions are not included so that the particle has a discontinuously varying refractive index.

The refractive index may alternate from layer to layer, or some other distribution of refractive index may be used. The layers may each have the same or different thickness, the same or different volumes, or some other variation in thickness or volume of the layers may be used. In some embodiments, the layers have a thickness that alternate between thick and thin.

The number of layers of a layered particle is not particularly limited, but may vary in any suitable range. In some embodiments, the particle includes a first region and a second region including at least 2, or at least 3, or at least 5, or at least 10, or at least 15, or at least 20 layers and including less than 300, less than 250, less than 200, less than 150, or less than 100 layers.

In some embodiments, a composition that includes a matrix (e.g., a resin or an adhesive) and a plurality of the particles of the present description is provided. The matrix may be substantially transparent (e.g., a layer of the matrix or a layer of the composition may transmit at least 80 percent, or at least 90 percent of light in the wavelength range of 400 to 700 nm) and may have a first refractive index which may be similar to a second refractive index at an outer surface of the particle. For example, an absolute value of the difference between the first and second refractive indexes may be less than 0.05, or less than 0.3, or less than 0.02 or less than 0.01. In some embodiments, the matrix material is substantially excluded from the particles so that the refractive index of the particle at an outer surface of the particle is not changed by incorporating the particle into the matrix. This may occur, for example, when the particles are dispersed in a polymer layer such as a polymeric pressure sensitive adhesive. In some embodiments, the material of the matrix partially penetrates into outer portions of the particles so that the refractive index of the particle at an outer surface of the particle is shifted by the presence of the matrix material in the outer portions of the particles. In such embodiments, the refractive index difference between the outer portions of the particles and the matrix is lowered and may be substantially zero. The matrix material may partially penetrate into the particles if the matrix comprises monomers which may be subsequently cured (e.g., heat cured or radiation cured such as ultraviolet (UV) cured). The monomers may penetrate into the particles and then be cured in place when the matrix is cured.

Suitable substantially transparent matrix materials include polymers, copolymers, and/or optically clear adhesives. Suitable polymers or copolymers include polyacrylates, polymethacrylates, polyolefins, polyepoxides, polyethers, and copolymers thereof. Suitable adhesives which may be used as the matrix include pressure sensitive adhesives (PSAs) and hot-melt adhesives. The matrix material may be a curable liquid, such as a UV curable acrylate.

It has been found that particles of the present description can provide various optical properties that may be useful in certain applications. For example, in some embodiments, the composition containing the particles is used to form a film or an adhesive layer or one or more layers of a film including a plurality of layers. Such film or layers may be used to provide a scattering control layer that may be used in a display application. For example, a scattering control layer including the particles described herein may be used as an anti-sparkle layer that reduces the objectionable sparkle when included in a display. Sparkle in a display can be described as a grainy pattern that appears to move around or flicker with small changes in the position of the viewer relative to the display. Sparkle in a display can be caused by light from a pixel interacting with a non-uniformity in the in the optical path of the light, typically on the surface of a display. Light from a pixel may appear to move around or flicker as the viewer moves due to the interaction of the pixel light with the non-uniformity. Such non-uniformities can include structure or surface texture from a film or other layer that might be added to a display. For example, surface texture in anti-glare films is often included in order to reduce specular reflection from the surface thereby reducing glare. Non-uniformities that can generate sparkle also include fingerprints, scratches or other residue on the display surface. In some embodiments, the particles included in a scattering control layer or an anti-sparkle film are selected to give controlled diffraction, refraction or a combination thereof and when incorporated into a display can significantly reduce sparkle while substantially maintaining the perceived display resolution.

In some embodiments, a layer including particles of the present description may include other particles having other functionalities such as, for example, nanoparticles or nano-wires. In some embodiments, a hard coat layer may contain particles of the present description in an acrylate binder or matrix along with inorganic nanoparticles to increase the hardness of the layer. In some embodiments, the particles of the present description may be included in a material that is extruded to form an optical film or one or more layers in an optical film. In some embodiments, the particles of the present description may be included in an injection molded part by including the particles in a resin that is used to form the injection molded part.

FIG. 8 is a cross-sectional view of layer 801, which may be a scattering control layer that may be suitable for use as an anti-sparkle film or as a layer in an anti-sparkle film. Layer 801 includes a plurality of particles 800 which may correspond to any of the particles described herein. A collimated beam of light 840 is schematically illustrated in FIG. 8. When collimated beam of light 840 passes through layer 801 an output distribution 842 of light is produced. In some embodiments, when the collimated beam of light 840 passes through the layer 801 (or through an anti-sparkle film including layer 801), more than about 30 percent of the collimated light beam is scattered by between 2 and 10 degrees measured in air, and less than 30 percent of the collimated light beam is scattered by more than 10 degrees measured in air. In some embodiments, when the collimated beam of light 840 passes through the layer 801 (or through an anti-sparkle film including layer 801), a light output distribution includes a central lobe region, a ring region, and a low intensity region separating the central lobe region and the ring region. Layer 801 may be said to provide controlled diffraction, refraction or a combination or diffraction and refraction.

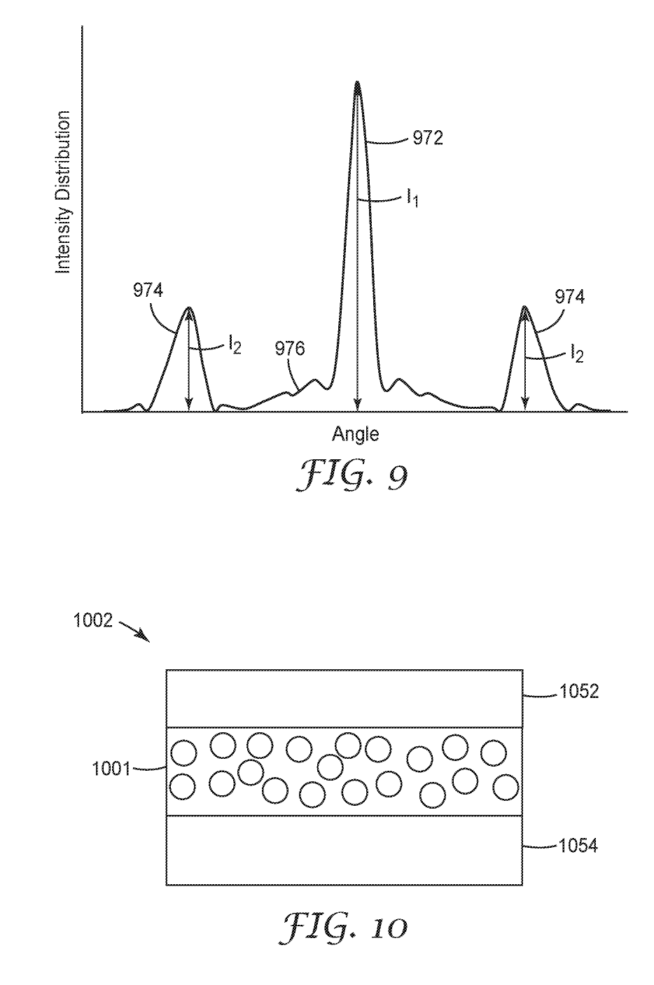

A light output distribution that could be generated when the collimated beam of light 840 passes through the layer 801 (or through an anti-sparkle film including layer 801) is schematically illustrated in FIG. 9 which shows a plot of the output distribution as a function of scattering angle. The output distribution includes a central lobe region 972 having a first maximum intensity of I₁ and includes a ring region 974 having a second maximum intensity of I₂. In FIG. 9, a cross-section of ring region 974 appears as two peaks at the sides of the plot. The region 976 between the central lobe region 972 and the ring region 974 may have an intensity less than one half of I₁ and less than one half of I₂. In some embodiments, at least some portions of the region 976 between the central lobe region 972 and the ring region 974 may have an intensity less than 0.1 times I₁ and less than 0.1 times I₂. In some embodiments, I₂ divided by I₁ is in a range of about 0.05 to about 1.0. The difference in scattering angle between the location of the maximum intensity I₂ in the ring region 974 and the location of the maximum intensity I₁ in the central lobe region 972 may be greater than 1 degree, or greater than 2 degrees, or greater than 3 degrees and may be less than 30 degrees, or less than 25 degrees, or less than 20 degrees. The location of the maximum intensity I₁ in the central lobe region 972 may be at a scattering angle having a magnitude of less than 1 degree or may be at a substantially zero scattering angle.

In some embodiments, a multilayer film is provided where at least one layer of the multilayer film is a composition that includes particles according to the present description. An example is illustrated in FIG. 10 which shows a multilayer film 1002 having three layers including layer 1001, which may correspond to layer 801, for example. Multilayer film further includes layer 1052, which may be a hard coat layer, for example, and layer 1054, which may be an adhesive layer for example. The hard coat layer may be formed from a resin that when cured is hard enough to provide adequate pencil hardness or abrasion resistance in applications where the material can be an outer layer. For example, the cured hard coat resin may provide a pencil hardness greater than HB or greater than H. Suitable hard coat resins include acrylic resins that may include inorganic nanoparticles. Suitable adhesive layers, which may be optically clear adhesive layers, include pressure sensitive adhesives (PSAs) and hot-melt adhesives.

Useful adhesives that may be used in layer 1054 and/or that may be used as the matrix in layer 1001 include elastomeric polyurethane or silicone adhesives and the viscoelastic optically clear adhesives CEF22, 817x, and 818x, all available from 3M Company, St. Paul, Minn. Other useful adhesives include PSAs based on styrene block copolymers, (meth)acrylic block copolymers, polyvinyl ethers, polyolefins, and poly(meth)acrylates. Multilayer film 1002 may be used as an anti-sparkle film that can be adhered to an outer surface of a display.

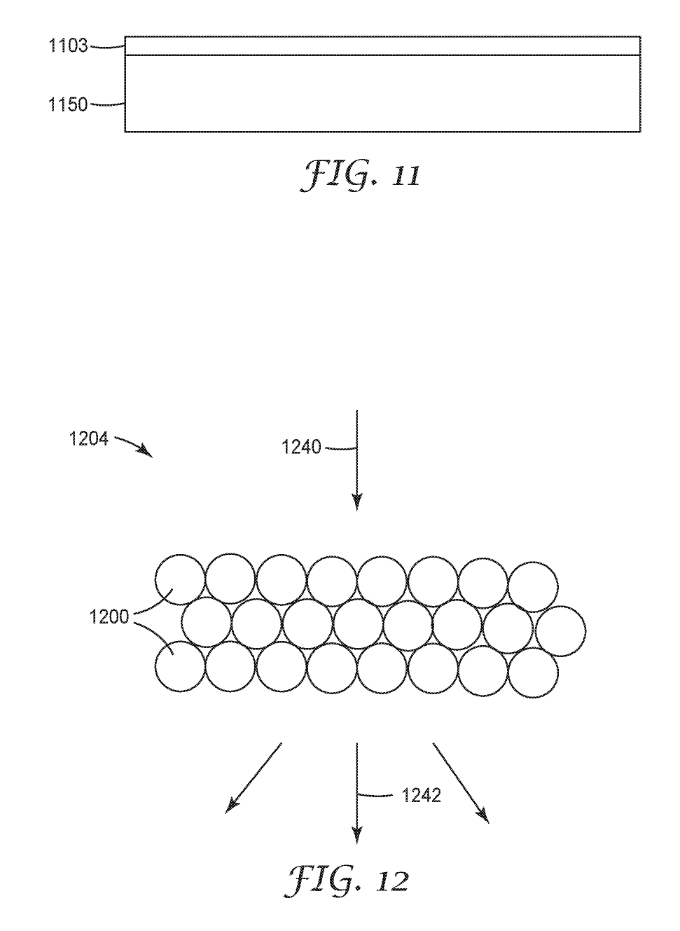

FIG. 11 schematically illustrates film or layer 1103 disposed on a display 1150. Film or layer 1103 may correspond to layer 801 or multilayer film 1002, for example. Film or layer 1103 may be a scattering control layer or an anti-sparkle film, for example.

In some aspect of the present description, one or more ordered layers of the particles described herein is provided. The total number of layers may be, for example in a range of 1 to 3. Using only a few layers (e.g., one, two or three layers) allows the optical effects of individual particles to be retained. FIG. 12 shows one or more ordered layers 1204 which includes particles 1200 arranged into three ordered layers. One or more ordered layers 1204 can be prepared via solution deposition onto a substrate, for example. A collimated beam of light 1240 is schematically illustrated in FIG. 12. When collimated beam of light 1240 passes through one or more ordered layers 1204 an output distribution of light 1242 is produced. In some embodiments, when the collimated beam of light 1240 passes through the one or more ordered layers of particles 1204, more than about 30 percent of the collimated light beam is scattered by between 2 and 10 degrees measured in air, and less than 30 percent of the collimated light beam is scattered by more than 10 degrees measured in air. In some embodiments, when the collimated beam of light 1240 passes through one or more layers 1204, a light output distribution includes a central lobe region, a ring region, and a low intensity region separating the central lobe region and the ring region as shown schematically in FIG. 9. In some embodiments, the region between the central lobe region and the ring region may have an intensity less than one half of the first maximum intensity I₁ of the lobe region and less than one half of the second maximum intensity I₂ of the ring region. In some embodiments, at least some portions of the region between the central lobe and the ring region may have an intensity less than 0.1 times I₁ and less than 0.1 times I₂. In some embodiments, the second maximum intensity divided by the first maximum intensity is in a range of about 0.05 to about 1.0. In some embodiments, the difference in scattering angle between the location of the maximum intensity I₂ in the ring region and the location of the maximum intensity I₁ in the central lobe region may be greater than 1 degree, or greater than 2 degrees, or greater than 3 degrees and may be less than 30 degrees, or less than 25 degrees, or less than 20 degrees. One or more ordered layers 1204 may be said to provide controlled diffraction, refraction or a combination or diffraction and refraction.

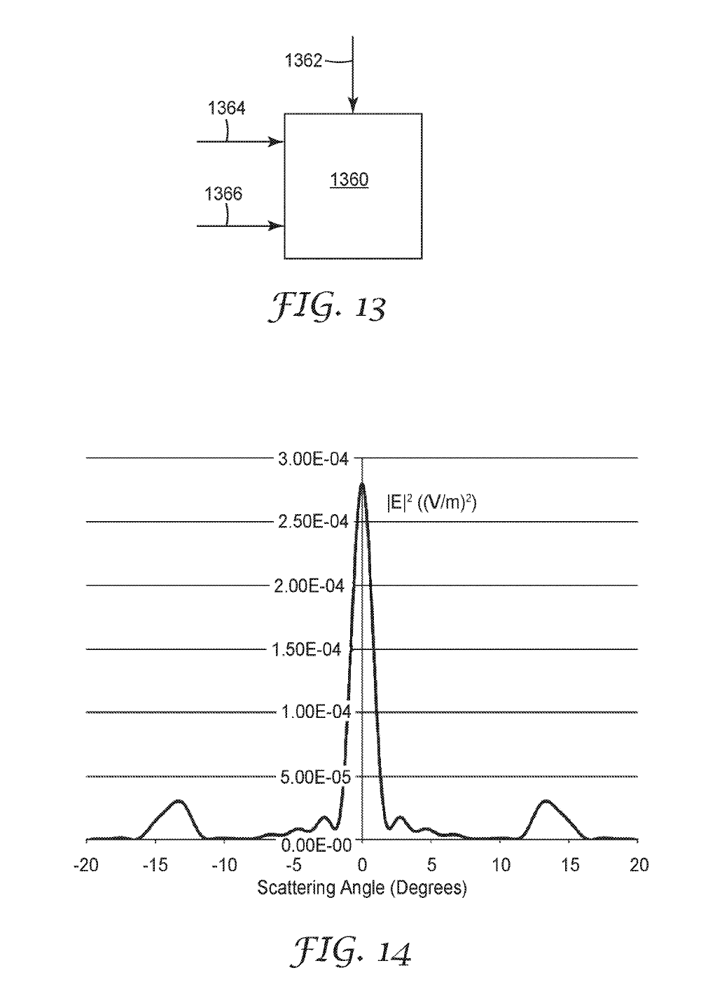

FIG. 13 schematically illustrates a method for making particles according to the present description using reactor 1360. The reactor 1360 is initially charged with one or more seed particles 1362 which may be in a solution. Monomers are provided to the seeds through first and second monomer streams 1364 and 1366. One or both of first and second monomer streams 1364 and 1366 may include initiators in addition to the monomers. First and second monomer streams 1364 and 1366 contain different compositions of monomers. First monomer stream 1364 may contain different monomers from the monomers in second monomer stream 1366, or first and second monomer streams 1364 and 1366 may contain different blends of the same or overlapping set or sets of monomers. The total flow rate of first and second monomer streams 1364 and 1366 may be constant or may vary continuously or discontinuously during the growth of the particle. It is desired to continuously provide the monomers to the growing particle so that copolymers spanning the second region of the particle are formed. As such, it is desired that the total flow rate of the first and second monomer streams 1364 and 1366 remain greater than zero until the growth of the particles are substantially complete, though the particles may continue to react with any remaining monomer in reactor 1360 after the flow of first and second monomer streams have ended. The size of the seeds and the size of the particles after the reaction has completed may be in any of the ranges described elsewhere herein. For example, the final particle size may be at least 2 times, or at least 5 times, or at least 10 times the diameter of the seed.

The flow rate of the first and second monomer streams may each vary continuously to produce a single layer having a radially varying composition and a radially varying refractive index that each varies continuously through the region of the grown particle exterior to the seed, or the flow rate of the first and second monomer streams may be varied discontinuously to produce a plurality of layers. Particles with layers having transition regions between the layers, as described elsewhere herein, can be formed by a suitable selection of the monomer flow rates.

In some embodiments, the monomers provided to the growing particles include molecules of a first type and molecules of a second type and the ratio of the number of monomers of the first type to the number of molecules of the second type varies with time. For example, first monomer stream 1364 may include molecules of the first type, second monomer stream 1366 may include molecules of the second type, and the relative flow rates of the first and second monomer streams 1364 and 1366 may be varied with time. In some embodiments, the monomers provided to the growing particles include molecules of a first type at a first time and molecules of a second type different from the first type at a second time. In some embodiments, the monomers provided to the growing particle consist essentially of molecules of the first type at the first time and consist essentially of molecules of the second type at the second time.

Any suitable number of monomer streams may be provided to the reactor. In the embodiment illustrated in FIG. 13, only two monomer streams are provided. In other embodiments, more than two monomer streams may be provided. For example, 3, 4 or more monomer streams may be provided. Using more than two monomer streams allows more complex distributions of monomer in the particles. For example, particles having layers of the form ABCABC can be formed where A, B and C represent layers having three distinct monomers.

### EXAMPLES

Particles with varying refractive index were prepared by reacting monomers adjacent the surface of a seed and growing the particle. An Anti-Sparkle film was prepared by coating a mixture of adhesive and particles on a film.

These examples are merely for illustrative purposes only and are not meant to be limiting on the scope of the appended claims. All parts, percentages, ratios, etc. in the examples and the rest of the specification are by weight, unless noted otherwise.

### Materials:

| RM | Supplier | Location |
|---|---|---|
| Rhodacal DS-10 | Rhodia, Inc. | Cranbury, New Jersey |
| Sodium bicarbonate | Fisher Scientific | Fairlawn, New Jersey |
| Styrene, Refractive index | Lyondell Chemical Company, | Houston, Texas |
| of 1.59-1.592 (20° C.) | | |
| Potassium persulfate | Alfa Aesar | Ward Hill, Massachusetts |
| Sodium metabisulfate | Esseco USA LLC | Parsippany, New Jersey |
| Iron (II) sulfate | Alfa Aesar | Ward Hill, Massachusetts |
| heptahydrate | | |
| VA-061 | Wako Pure Chemical Industries, Ltd. | Osaka, Japan |
| Methyl methacrylate, | Dow Chemical Company | Philadelphia, Pennsylvania |
| Index of 1.4893 (23° C.), | | |
| 1.490 (20° C.) | | |
| Emulsion PSA, | As described in Example 1 of U.S. | |
| Refractive index of | Pat. No. 4,629,663 (Brown et al.) | |
| 1.4753 | | |
| Anti-glare film substrate | Available from 3M Company under | St. Paul, MN |
| | the trade name 3M Natural View | |
| | Screen Protector | |

The styrene was passed through a column of silica to remove the inhibitor before adding. All the other raw materials (RMs) were used as received unless otherwise specified.

Equipment:

| Instrument | Manufacturer | Model | Location |
|---|---|---|---|
| Particle size | Coulter Electronics, | N4MD Sub-micron | Hialeah, |
| analyzer | Inc. | Particle Analyzer | Florida |
| Sparkle | Display-Messtechnik | SMS 1000 | Karlsruhe, |
| Measurement | & Systeme | | Germany |
| System | | | |

### Test Method:

### Particle Size

A particle size analyzer (N4MD Sub-micron Particle Analyzer) was used to measure the size of the particles. The input material was diluted to an intensity range of 5.00 E+04 to 1.00 E+06 counts per second, as instructed in the manufacturer's directions.

### Examples

### Seed Particle 1 Preparation

Seed Particles were grown in a 2000 mL flask, equipped with a variable speed agitator, purging tube for nitrogen, condenser, and a recording controller. The materials in Table 1 were charged to the flask while purging with 1 lpm of nitrogen.

TABLE 1

| RM | Amount (grams) |
|---|---|
| Deionized Water | 573 |
| Rhodacal DS-10 | 6.3 |
| Sodium bicarbonate | 0.5 |
| Styrene | 650 |

The flask was stirred at 250 rpm and heated to 50° C. while the nitrogen purge continued for 1 hour, after which time an initiator charge of 0.55 g of potassium persulfate, 0.22 g of sodium meta-bisulfite, and 0.91 g of iron (II) sulfate heptahydrate (0.2% aqueous solution) were added to the flask. An increase in reaction temperature indicated the start of polymerization, and the nitrogen purge was decreased to 0.5 lpm. The time between the start of the reaction and the peak temperature of 70° C. was 31 minutes. At this point, the temperature was increased to 80° C. and held for 2 hours to complete polymerization. The resulting material was filtered through cheesecloth.

Seed Particles 1 were measured the using the Test Method described above.

Seed Particle 1 Size—105 nm mean diameter, 99.8-110 nm 95% limits, 31 nm standard deviation (S.D.).

### Seed Particle 2 Preparation

Seed Particles were grown in a 32 oz (946 ml) narrow mouth amber bottle. The material in Table 2 was charged to the bottle, then purged with 3 lpm of nitrogen for 10 minutes and then sealed.

TABLE 2

| RM | Amount (grams) |
|---|---|
| Deionized Water | 640 |
| Styrene | 28.8 |
| Potassium persulfate | 0.6 |

The bottle was placed in a rotating water bath where it was tumbled at 35 rpm and heated to 70° C. for 24 hours. The resulting material was filtered through cheesecloth.

Seed Particles 2 were measured using the Test Method described above.

Seed Particle 2 Size—269 nm mean diameter, 249-290 nm 95% limits, 82 nm S.D.

### Reference Particle 1 Step 1

Particles were grown in a 2000 mL flask, equipped with a variable speed agitator, purging tube for nitrogen, condenser, and a recording controller. A charge of 80 g of Seed Particle 1 was added to the flask, along with an initiator charge of 10 g of VA-061 (1% aqueous solution), all while purging with 1 lpm of nitrogen. The flask was stirred at 120 rpm and heated to 80° C., at which temperature the nitrogen purge was decreased to 0.5 lpm and two feeds began pumping into the flask. Two syringe pumps were used to supply the two feeds. Feed one held the aqueous inputs and feed two held the organic inputs. The material in Table 3 was added to 4 oz (118 ml) narrow mouth glass jars (a jar for each feed) and the jars were fitted with septa and purged with nitrogen at 3 lpm for 10 minutes.

TABLE 3

| | Amount (grams) |
|---|---|
| RM - Feed One | |
| Deionized water | 76.7 |
| VA-061 | 0.08 |
| Rhodacal DS-10 | 1.2 |
| RM - Feed Two (90/10) | |
| Styrene | 75.6 |
| Methyl methacrylate | 8.4 |

The inputs were syringed out of the jars, placed in the syringe pumps, and connected to the flask. The pump program is listed in Table 4.

TABLE 4

| | Time | Feed One Flowrate | Feed Two Flowrate |
|---|---|---|---|
| Step | (min) | (mL/min) | (mL/min) |
| 1 | 60 | 1.30 | 1.535 |

When the feeds stopped, the temperature was held at 80° C. for 30 minutes to complete polymerization. The resulting material was filtered through cheesecloth.

Measurements where made using the Test Method described above.

Reference Particle 1 Step 1 Size—133 nm mean diameter, 126-140 nm 95% limits, narrow S.D.

### Reference Particle 1 Step 2

The material from Step 1 was left in the flask and purged with 1 lpm of nitrogen. The same procedure and equipment described above were used. The material in Table 5 below was added to 8 oz (237 ml) narrow mouth glass jars (ajar for each feed) and the jars were fitted with septa and purged with nitrogen at 3 lpm for 10 minutes.

TABLE 5

| | Amount (grams) |
|---|---|
| RM - Feed One | |
| Deionized water | 152.6 |
| VA-061 | 0.15 |
| Rhodacal DS-10 | 3.3 |
| RM - Feed Two (80/20) | |
| Styrene | 134.4 |
| Methyl methacrylate | 33.6 |

The inputs were syringed out of the jars, placed in the syringe pumps, and connected to the flask. The pump program is listed in Table 6 below:

TABLE 6

| | Time | Feed One Flowrate | Feed Two Flowrate |
|---|---|---|---|
| Step | (min) | (mL/min) | (mL/min) |
| 2 | 120 | 1.30 | 1.530 |

When the feeds stopped, the temperature was held at 80° C. for 30 minutes to complete polymerization. The resulting material was filtered through cheesecloth.

Measurements where made using the Test Method described above.

Reference Particle 1 Step 2 Size—185 nm mean diameter, 173-197 nm 95% limits, 55 nm S.D.

### Reference Particle 1 Step 3

The material from Step 2 (200 g) was left in the flask, along with an initiator charge of 25 g of VA-061 (1% aqueous solution), all while purging with 1 lpm of nitrogen. The same procedure and equipment described above were used. The material in Table 7 was added to 4 oz (118 ml) narrow mouth glass jars (a jar for each feed) and the jars were fitted with septa and purged with nitrogen at 3 lpm for 10 minutes.

TABLE 7

| | Amount (grams) |
|---|---|
| RM - Feed One | |
| Deionized water | 93.9 |
| VA-061 | 0.09 |
| Rhodacal DS-10 | 2.0 |
| RM - Feed Two (70/30) | |
| Styrene | 67.2 |
| Methyl methacrylate | 28.8 |

The inputs were syringed out of the jars, placed in the syringe pumps, and connected to the flask. The pump program is listed in Table 8.

TABLE 8

| | Time | Feed One Flowrate | Feed Two Flowrate |
|---|---|---|---|
| Step | (min) | (mL/min) | (mL/min) |
| 3 | 240 | 0.40 | 0.436 |

When the feeds stopped, the temperature was held at 80° C. for 30 minutes to complete polymerization. The resulting material was filtered through cheesecloth.

Measurements where made using the Test Method described above.

Reference Particle 1 Step 3 Size—200 nm mean diameter, 187-213 nm 95% limits, 47 nm S.D.

### Reference Particle 1 Step 4

A portion of the material from Step 3 (200 g) was left in the flask, along with an initiator charge of 25 g of VA-061 (1% aqueous solution), all while purging with 1 lpm of nitrogen. The same procedure and equipment described above were used. The material in Table 9 was added to 4 oz (118 ml) narrow mouth glass jars (ajar for each feed) and the jars were fitted with septa and purged with nitrogen at 3 lpm for 10 minutes.

TABLE 9

| | Amount (grams) |
|---|---|
| RM - Feed One | |
| Deionized water | 79.5 |
| VA-061 | 0.08 |
| Rhodacal DS-10 | 1.4 |
| RM - Feed Two (60/40) | |
| Styrene | 48.6 |
| Methyl methacrylate | 32.4 |

The inputs were syringed out of the jars, placed in the syringe pumps, and connected to the flask. The pump program is listed in Table 10.

TABLE 10

| | Time | Feed One Flowrate | Feed Two Flowrate |
|---|---|---|---|
| Step | (min) | (mL/min) | (mL/min) |
| 4 | 270 | 0.30 | 0.326 |

When the feeds stopped, the temperature was held at 80° C. for 30 minutes to complete polymerization. The resulting material was filtered through cheesecloth.

Measurements where made using the Test Method described above.

Reference Particle 1 Step 4 Size—224 nm mean diameter, 208-239 nm 95% limits, narrow S.D.

### Reference Particle 1 Step 5

A portion of the material from Step 4 (200 g) was left in the flask, along with an initiator charge of 25 g of VA-061 (1% aqueous solution), all while purging with 1 lpm of nitrogen. The same procedure and equipment described above were used. The material in Table 11 was added to 4 oz (118 ml) narrow mouth glass jars (ajar for each feed) and the jars were fitted with septa and purged with nitrogen at 3 lpm for 10 minutes.

TABLE 11

| | Amount (grams) |
|---|---|
| RM - Feed One | |
| Deionized water | 73.7 |
| VA-061 | 0.07 |
| Rhodacal DS-10 | 1.2 |
| RM - Feed Two (50/50) | |
| Styrene | 37.5 |
| Methyl methacrylate | 37.5 |

The inputs were syringed out of the jars, placed in the syringe pumps, and connected to the flask. The pump program is listed in Table 12.

TABLE 12

| | Time | Feed One Flowrate | Feed Two Flowrate |
|---|---|---|---|
| Step | (min) | (mL/min) | (mL/min) |
| 5 | 300 | 0.25 | 0.270 |

When the feeds stopped, the temperature was held at 80° C. for 30 minutes to complete polymerization. The resulting material was filtered through cheesecloth.

Measurements where made using the Test Method described above.

Reference Particle 1 Step 5 Size—244 nm mean diameter, 226-262 nm 95% limits, narrow S.D.

### Reference Particle 1 Step 6

A portion of the material from Step 5 (200 g) was left in the flask, along with an initiator charge of 25 g of VA-061 (1% aqueous solution), all while purging with 1 lpm of nitrogen. The same procedure and equipment described above were used. The material in Table 13 below was added to 4 oz (118 ml) narrow mouth glass jars (ajar for each feed) and the jars were fitted with septa and purged with nitrogen at 3 lpm for 10 minutes.

TABLE 13

| | Amount (grams) |
|---|---|
| RM - Feed One | |
| Deionized water | 53.2 |
| VA-061 | 0.05 |
| Rhodacal DS-10 | 0.7 |
| RM - Feed Two (40/60) | |
| Styrene | 21.6 |
| Methyl methacrylate | 32.4 |

The inputs were syringed out of the jars, placed in the syringe pumps, and connected to the flask. The pump program that was used is listed in Table 14 below:

TABLE 14

| | Time | Feed One Flowrate | Feed Two Flowrate |
|---|---|---|---|
| Step | (min) | (mL/min) | (mL/min) |
| 6 | 300 | 0.18 | 0.194 |

When the feeds stopped, the temperature was held at 80° C. for 30 minutes to complete polymerization. The resulting material was filtered through cheesecloth.

Measurements where made using the Test Method described above.

Reference Particle 1 Step 6 Size—269 nm mean diameter, 249-290 nm 95% limits, narrow S.D.

### Reference Particle 1 Step 7

A portion of the material from Step 6 (200 g) was left in the flask, along with an initiator charge of 25 g of VA-061 (1% aqueous solution), all while purging with 1 lpm of nitrogen. The same procedure and equipment described above were used. The material in Table 15 was added to 4 oz (118 ml) narrow mouth glass jars (ajar for each feed) and the jars were fitted with septa and purged with nitrogen at 3 lpm for 10 minutes.

TABLE 15

| | Amount (grams) |
|---|---|
| RM - Feed One | |
| Deionized water | 50.3 |
| VA-061 | 0.05 |
| Rhodacal DS-10 | 0.6 |
| RM - Feed Two (30/40) | |
| Styrene | 15.3 |
| Methyl methacrylate | 35.7 |

The inputs were syringed out of the jars, placed in the syringe pumps, and connected to the flask. The pump program is listed in Table 16.

TABLE 16

| | Time | Feed One Flowrate | Feed Two Flowrate |
|---|---|---|---|
| Step | (min) | (mL/min) | (mL/min) |
| 7 | 300 | 0.17 | 0.183 |

When the feeds stopped, the temperature was held at 80° C. for 30 minutes to complete polymerization. The resulting material was filtered through cheesecloth.

Measurements where made using the Test Method described above.

Reference Particle 1 Step 7 Size—292 nm mean diameter, 268-315 nm 95% limits, narrow S.D.

### Example Particle 1

Particles are grown as described for Reference Particle 1 except that the reactions are not stopped between steps. Instead, the raw material feed for each step is started immediately upon stopping the raw material feed for a previous step. The resulting particles have the sizes and layer structures described for Reference Particle 1, but since the reaction is not stopped, a copolymer extending from the seed to an outer surface of the particle is formed.

### Example Particle 2

Particles were grown in a 2000 mL flask, equipped with a variable speed agitator, purging tube for nitrogen, condenser, and a recording controller. A charge of 500 g of Seed Particle 2 was added to the flask, along with an initiator charge of 0.5 g of potassium persulfate, all while purging with 1 lpm of nitrogen. The flask was stirred at 170 rpm and heated to 70° C., at which temperature the nitrogen purge was decreased to 0.5 lpm and three feeds began pumping into the flask. Three syringe pumps were used to supply the three feeds. Feed one held the aqueous inputs, feed two held the styrene input, and feed three held the methyl methacrylate input. The material in Table 17 was added to narrow mouth glass jars (ajar for each feed; 16 oz (473 ml) jar for feed one, 4 oz (118 ml) jars for feeds two and three) and the jars were fitted with septa and purged with nitrogen at 3 lpm for 10 minutes.

TABLE 17

| | Amount (grams) |
|---|---|
| RM - Feed One | |
| Deionized water | 383 |
| Potassium persulfate | 0.77 |
| Rhodacal DS-10 | 0.38 |
| RM - Feed Two | |
| Styrene | 72.1 |
| RM - Feed Three | |
| Methyl methacrylate | 72.2 |

The inputs were syringed out of the jars, placed in the syringe pumps, and connected to the flask. The pump program that was used is listed in Table 18. Note that the flow rate for Feed One remained constant while Feed Two and Feed Three varied linearly over the feed time.

TABLE 18

| | | Feed One | Feed Two | | Feed Three | |
|---|---|---|---|---|---|---|
| | Time | Flowrate | Flowrate (mL/min) | | Flowrate (mL/min) | |
| Step | (min) | (mL/min) | Start | End | Start | End |
| 1 | 480 | 0.8 | 0.330 | 0.000 | 0.000 | 0.319 |

When the feeds stopped, the temperature was held at 40° C. for 1 hour to complete polymerization. The resulting material was filtered through cheesecloth.

Measurements where made using the Test Method described above.

Example Particle 2 Size—436 nm mean diameter, 393-478 nm 95% limits, narrow S.D.

A summary of particle size data is shown in Table 19. The volumes were calculated using the diameters listed above and using the formula for a volume of a sphere (volume=4π/3 times the radius cubed). The percent volume of the second region was determined as 100 percent times (Total Volume−Seed Volume)/Total Volume.

TABLE 19

| | | | % Volume |
|---|---|---|---|
| | Diameter | Total Volume | of 2^{nd} |
| Particle | (nm) | (10⁶ nm³) | Region |
| Seed Particle 1 | 105 | 0.606 | — |
| Seed Particle 2 | 269 | 10.2 | — |
| Reference Particle 1 Step 1 | 133 | 1.23 | 50.8% |
| Reference Particle 1 Step 2 | 185 | 3.32 | 81.7% |
| Reference Particle 1 Step 3 | 200 | 4.19 | 85.5% |
| Reference Particle 1 Step 4 | 224 | 5.88 | 89.7% |
| Reference Particle 1 Step 5 | 244 | 7.61 | 92.0% |
| Reference Particle 1 Step 6 | 269 | 10.2 | 94.1% |
| Reference Particle 1 Step 7 | 292 | 13.0 | 95.4% |
| Example Particle 2 | 436 | 43.4 | 76.5% |

### Anti-Sparkle Film

The following materials were mixed together and placed on a roller for 1 hour:

### 90.8 wt % of Emulsion PSA

9.2 wt % of particles as made in Reference Particle 1 Step 7

This mixture was then coated onto an anti-glare film substrate. The coating was on the side opposite the anti-glare coated side. A benchtop knife coater, with the gap set to 5 mils (127 microns), was used to coat the solution onto the substrate. After it was pulled through the knife coater it was placed in a 110° C. oven for 10 minutes. The film was cut to size and laminated to a 7″ KINDLE FIRE HDX. Sparkle was measured using an SMS 1000 Sparkle Measurement System.

Similar optical properties are expected for a film made in the same way, but using Example Particle 1 instead of Reference Particle 1.

### Comparative Film

An adhesive coated anti-glare film was used as a Comparative Film for sparkle. 90.8 wt % of an Emulsion PSA was coated onto the film and dried as described above. The adhesive did not have the particles added to it. The film was cut to size and laminated to a 7″ KINDLE FIRE HDX. Sparkle was measured using an SMS 1000 Sparkle Measurement System.

The Comparative Film had a sparkle reading of 12.4 and the Anti-Sparkle Film had a sparkle reading of 8.7.

### Scattering Control Layers

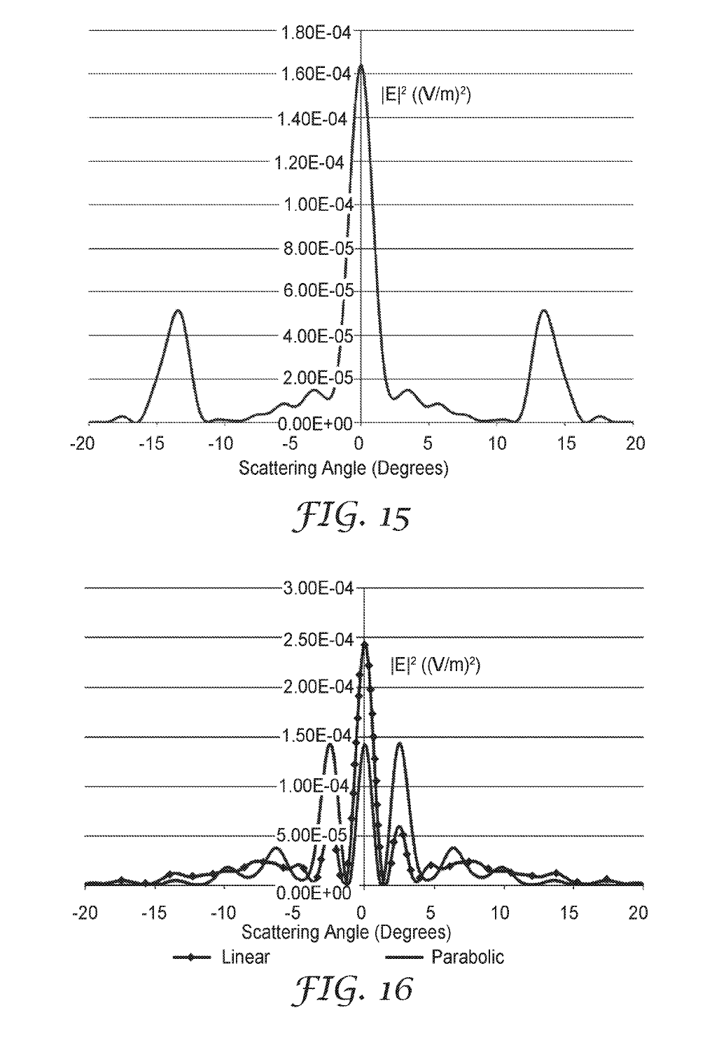

The optical properties of particles dispersed in a matrix were calculated using Lumerical finite-difference time-domain (FDTD) simulation software (version 8.6.0, available from Lumerical Solutions, Vancouver, B.C., Canada). Scattering control layers having particles with a varying refractive index were simulated using the FDTD simulations. The particles were modeled as having a seed (first region) with a refractive index of 1.55 and an outer region (second region) with refractive index of 1.685 adjacent the seed and a refractive index of 1.47 at the surface. The seed diameter was 0.3 micrometers and the particles had an outer diameter of 6 micrometers (3 micrometer radius). The particles were dispersed in a matrix having a refractive index of 1.47. The particles were assumed to have a low particle density so that the scattering profile determined by a single particle would be representative of the scattering control layer. The far field electric field squared (|E|²) was determined by the simulation software and this is proportional to the intensity of the transmitted light. The scattering profile (light output distribution (|E∥² or intensity) as a function of scattering angle) was determined for a linear refractive index gradient and for a parabolic refractive index profile. The resulting profiles are shown in FIGS. 14 and 15 for the linear and parabolic refractive index profiles respectively. Each plot shows a light output distribution having a central lobe region, a ring region, and a low intensity region separating the central lobe region and the ring region. Using particles having a parabolic refractive index profile produced a stronger ring region which may be desirable in some applications.

The simulation was repeated for particles having a 2 micrometer diameter (1 micrometer radius) and the results are shown in FIG. 16. Each light output distribution had a central lobe region, a ring region, and a low intensity region separating the central lobe region and the ring region. Using particles having a parabolic refractive index profile again produced a stronger ring region than using particles with a linear refractive index profile and this may be desirable in some applications.

The following is a list of exemplary embodiments of the present description.

Embodiment 1 is a particle having a first region and a second region surrounding the first region, wherein a volume of the second region is at least 75 percent of a volume of the particle, wherein the second region comprises a copolymer extending across a thickness of the second region, and wherein the particle has a composition and a refractive index that each vary across the thickness of the second region.

Embodiment 2 is the particle of embodiment 1, wherein the volume of the second region is at least 85 percent of the volume of the particle.

Embodiment 3 is the particle of embodiment 1, wherein the volume of the second region is at least 95 percent of the volume of the particle.

Embodiment 4 is the particle of embodiment 1, wherein the volume of the second region is at least 99 percent of the volume of the particle.

Embodiment 5 is the particle of embodiment 1, wherein the volume of the second region is at least 99.9 percent of the volume of the particle.

Embodiment 6 is the particle of embodiment 1, wherein a difference between a maximum refractive index in the second region and a minimum refractive index in the second region is at least 0.05.

Embodiment 7 is the particle of embodiment 1, wherein a difference between a maximum refractive index in the second region and a minimum refractive index in the second region is at least 0.1.

Embodiment 8 is the particle of embodiment 1, wherein the refractive index varies monotonically across the thickness of the second region.

Embodiment 9 is the particle of embodiment 1, wherein the refractive index varies non-monotonically across the thickness of the second region.

Embodiment 10 is the particle of embodiment 9, wherein the refractive index has a substantially sinusoidal variation across the thickness of the second region.

Embodiment 11 is the particle of embodiment 10, wherein the substantially sinusoidal variation has an amplitude of at least 0.05.

Embodiment 12 is the particle of embodiment 1, wherein the first region has a diameter in a range of about 1 nm to about 400 nm.

Embodiment 13 is the particle of embodiment 1, wherein the particle has an outer diameter in a range of about 100 nm to about 10 micrometers.

Embodiment 14 is the particle of embodiment 1, wherein the composition and the refractive index each varies continuously across the thickness of the second region Embodiment 15 is the particle of embodiment 14, wherein the refractive index varies continuously from a center of the particle to an outer surface of the particle.

Embodiment 16 is the particle of embodiment 14, wherein the refractive index varies at a nonzero first rate at a first position in the second region and at a nonzero second rate different from the first rate at a second position in the second region, the second position further from a center of the particle than the first position.

Embodiment 17 is the particle of embodiment 16, wherein an absolute value of the second rate is higher than an absolute value of the first rate.

Embodiment 18 is the particle of embodiment 17, wherein the first and second positions are radially separated by at least 80 percent of the thickness of the second region.

Embodiment 19 is the particle of embodiment 14, wherein an absolute value of a derivative of the refractive index with respect to a radial coordinate monotonically increases with increasing radial coordinate across at least 80 percent of the thickness of the second region.

Embodiment 20 is the particle of embodiment 14, wherein an absolute value of a derivative of the refractive index with respect to a radial coordinate monotonically increases with increasing radial coordinate across the thickness of the second region.

Embodiment 21 is the particle of embodiment 1, wherein the second region comprises:
a plurality of mutually concentric layers, each layer having a substantially constant refractive index,
   wherein adjacent layers have different refractive indices.

Embodiment 22 is the particle of embodiment 21, wherein a refractive index difference between adjacent layers is at least 0.05.

Embodiment 23 is the particle of embodiment 21, wherein a refractive index difference between adjacent layers is at least 0.1.

Embodiment 24 is the particle of embodiment 21, wherein the layers have alternating refractive indices.

Embodiment 25 is the particle of embodiment 21, wherein adjacent layers have differing thicknesses.

Embodiment 26 is the particle of embodiment 21, wherein the layers have alternating thicknesses.

Embodiment 27 is the particle of embodiment 21, wherein each layer has a thickness in a range of about 30 nm to about 500 nm.

Embodiment 28 is the particle of embodiment 21, further comprising transition regions between adjacent layers, wherein each of the transition regions have a continuously varying refractive index and a thickness less than about ⅓ of a minimum thickness of the immediately adjacent layers.

Embodiment 29 is the particle of embodiment 28, wherein the thickness of each of the transition regions is less than about ⅕ of the minimum thickness of the immediately adjacent layers.

Embodiment 30 is the particle of embodiment 21 comprising at least three mutually concentric layers.

Embodiment 31 is the particle of embodiment 21 comprising at least 5 mutually concentric layers.

Embodiment 32 is the particle of embodiment 21 comprising 3 to 300 mutually concentric layers.

Embodiment 33 is the particle of embodiment 21 comprising 5 to 300 mutually concentric layers.

Embodiment 34 is the particle of embodiment 1, wherein the particle is substantially spherical.

Embodiment 35 is a composition comprising:

a substantially transparent matrix having a first refractive index; and
a plurality of the particles of any of embodiments 1 to 34 dispersed in the matrix,
wherein each of the particles have a second refractive index at an outer surface of the particle, and
wherein an absolute value of a difference between the first and second refractive indices is less than 0.05.

Embodiment 36 is the composition of embodiment 35, wherein the absolute value of the difference between the first and second refractive indices is less than 0.02.

Embodiment 37 is the composition of embodiment 35, wherein a material of the matrix partially penetrates into outer portions of the particles.

Embodiment 38 is the composition of embodiment 35, wherein the matrix is substantially excluded from the particles.

Embodiment 39 is the composition of embodiment 35, wherein the composition is an adhesive.

Embodiment 40 is a scattering control layer comprising the composition of embodiment 35.

Embodiment 41 is the scattering control layer of embodiment 40, wherein when a collimated beam of light passes through the scattering control layer, a light output distribution comprises a central lobe region, a ring region, and a low intensity region separating the central lobe region and the ring region.

Embodiment 42 is the scattering control layer of embodiment 40, wherein more than about 30 percent of a collimated beam of light passing through the scattering control layer is scattered by between 2 and 10 degrees measured in air, and less than 30 percent of the collimated beam of light is scattered by more than 10 degrees measured in air.

Embodiment 43 is an anti-sparkle film comprising the scattering control layer of embodiment 40.

Embodiment 44 is the anti-sparkle film of embodiment 43, wherein more than about 30 percent of a collimated beam of light passing through the anti-sparkle film is scattered by between 2 and 10 degrees measured in air, and less than 30 percent of the collimated beam of light is scattered by more than 10 degrees measured in air.

Embodiment 45 is the anti-sparkle film of embodiment 43, wherein when a collimated beam of light passes through the anti-sparkle, a light output distribution comprises a central lobe region, a ring region, and a low intensity region separating the central lobe region and the ring region.

Embodiment 46 is a display comprising the scattering control layer of any of embodiments 40 to 42 or the anti-sparkle film of any of embodiments 43 to 45.

Embodiment 47 is a display comprising a layer comprising the composition of any of embodiments 35 to 39.

Embodiment 48 is a film comprising one or more layers, at least some of the layers comprising the composition of any of embodiments 35 to 39.

Embodiment 49 is one or more ordered layers of the particles of any of embodiment 1 to 39.

Embodiment 50 is the one or more ordered layers of embodiment 49, wherein a total number of the ordered layers is in a range of 1 to 3.

Embodiment 51 is a method of making a particle comprising:
providing a seed;
providing monomers;
reacting the monomers adjacent a surface of the seed; and
growing the particle until the particle has an outer diameter at least twice a diameter of the seed by reacting the monomers adjacent a surface of the growing particle,
   wherein the monomers are continuously provided to the growing particle and wherein a composition of the monomers provided to the growing particle is changed with time.

Embodiment 52 is the method of embodiment 51, wherein a single layer is formed, the single layer having a composition and a refractive index that each varies continuously from a surface of the seed to an outer surface of the particle.

Embodiment 53 is the method of embodiment 52, wherein the single layer comprises a copolymer having a radially varying composition and a radially varying refractive index.

Embodiment 54 is the method of embodiment 53, wherein the copolymer extends from the seed to an outer surface of the particle.

Embodiment 55 is the method of embodiment 52, wherein the composition of the single layer immediately adjacent the seed is substantially the same as that of the seed and wherein the composition and the refractive index each varies continuously from the center of the particle to an outer surface of the particle.

Embodiment 56 is the method of embodiment 51, wherein the monomers include molecules of a first type and molecules of a second type and a ratio of the number of molecules of the first type to the number of molecules of the second type varies with time.

Embodiment 57 is the method of embodiment 51, wherein the monomers include molecules of a first type at a first time and molecules of a second type different from the first type at a second time.

Embodiment 58 is the method of embodiment 57, wherein the monomers consist essentially of molecules of the first type at the first time and consist essentially of molecules of the second type at the second time.

Embodiment 59 is the method of embodiment 51, wherein a plurality of layers are formed, each layer having a differing composition from an adjacent layer.

Embodiment 60 is the method of embodiment 59, wherein adjacent layers have refractive indices that differ by at least 0.05.

Embodiment 61 is the method of embodiment 59, wherein adjacent layers are separated by transition regions and wherein the refractive index varies continuously through each transition region.

Embodiment 62 is the method of embodiment 59, wherein the particle comprises a copolymer extending from the seed to an outer surface of the particle.

Embodiment 63 is the method of embodiment 51, wherein the growing step continues until the outer diameter of the particle is at least 10 times the diameter of the seed.

Embodiment 64 is an article comprising one or more ordered layers of particles, wherein at least some of the particles have a refractive index that varies over at least 50 percent of a diameter of the particle, and wherein when a collimated beam of light passes through the article, a light output distribution comprises a central lobe region, a ring region, and a low intensity region separating the central lobe region and the ring region.

Embodiment 65 is the article of embodiment 64, wherein a total number of the layers in the one or more layers of ordered particles is in a range of 1 to 3.

Embodiment 66 is the article of embodiment 64, wherein the central lobe region has a first maximum intensity, the ring region has a second maximum intensity, and the low intensity region has an intensity less than ½ the first maximum intensity and less than ½ the second maximum intensity.

Embodiment 67 is the article of embodiment 66, wherein the second maximum intensity divided by the first maximum intensity is in a range of about 0.05 to about 1.0.

Embodiment 68 is the article of embodiment 64, wherein at least some of the particles comprise a copolymer extending over at least 50 percent of a diameter of the particle and wherein a composition of the copolymer varies over at least 50 percent of the diameter of the particle.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A particle having a first region and a second region surrounding the first region, wherein a volume of the second region is at least 75 percent of a total volume of the particle, wherein the second region comprises a copolymer extending across a thickness of the second region, and wherein the particle has a composition and a refractive index that each varies across the thickness of the second region.

2. The particle of claim 1, wherein a difference between a maximum refractive index in the second region and a minimum refractive index in the second region is at least 0.05.

3. The particle of claim 1, wherein the composition and the refractive index each varies continuously across the thickness of the second region

4. The particle of claim 3, wherein an absolute value of a derivative of the refractive index with respect to a radial coordinate monotonically increases with increasing radial coordinate across at least 80 percent of the thickness of the second region.

5. The particle of claim 1, wherein the second region comprises a plurality of mutually concentric layers, each layer having a substantially constant refractive index, wherein adjacent layers have different refractive indices.

6. The particle of claim 5, further comprising transition regions between adjacent layers,
wherein each of the transition regions have a continuously varying refractive index and a thickness less than about ⅓ of a minimum thickness of the immediately adjacent layers.

7. A composition comprising:
a substantially transparent matrix having a first refractive index; and
a plurality of the particles of claim 1 dispersed in the matrix,
wherein each of the particles have a second refractive index at an outer surface of the particle, and wherein an absolute value of a difference between the first and second refractive indices is less than 0.05.

8. The composition of claim 7, wherein a material of the matrix partially penetrates into outer portions of the particles.

9. The composition of claim 7, wherein the matrix is substantially excluded from the particles.

10. A scattering control layer comprising the composition of claim 7, wherein when a collimated beam of light passes through the scattering control layer, a light output distribution comprises a central lobe region, a ring region, and a low intensity region separating the central lobe region and the ring region.

11. An anti-sparkle film comprising the scattering control layer of claim 10.

12. A method of making a particle comprising:
providing a seed;
providing monomers;
reacting the monomers adjacent a surface of the seed; and
growing the particle until the particle has an outer diameter at least twice a diameter of the seed by reacting the monomers adjacent a surface of the growing particle,
wherein the monomers are continuously provided to the growing particle and wherein a composition of the monomers provided to the growing particle is changed with time.

13. The method of claim 12, wherein a single layer is formed, the single layer having a composition and a refractive index that each varies continuously from a surface of the seed to an outer surface of the particle.

14. An article comprising one or more ordered layers of particles,
wherein each of a plurality of the particles is a particle according to claim 1, and wherein when a collimated beam of light passes through the article, a light output distribution comprises a central lobe region, a ring region, and a low intensity region separating the central lobe region and the ring region.

15. The article of claim 14, wherein at least some of the particles comprise a copolymer extending over at least 50 percent of a diameter of the particle and wherein a composition of the copolymer varies over at least 50 percent of the diameter of the particle.

16. A particle having a first region and a second region surrounding the first region, wherein a volume of the second region is at least 75 percent of a total volume of the particle, and wherein the particle has a composition and a refractive index that each varies continuously across a thickness of the second region.

17. The particle of claim 16, wherein the second region comprises a copolymer extending across the thickness of the second region.

18. The particle of claim 16, wherein the refractive index varies monotonically across the thickness of the second region.

19. The particle of claim 16, wherein a difference between a maximum refractive index in the second region and a minimum refractive index in the second region is at least 0.05.

20. The particle of claim 16, wherein an absolute value of a derivative of the refractive index with respect to a radial coordinate monotonically increases with increasing radial coordinate across at least 80 percent of the thickness of the second region.
